(19) United States
(12) Patent Application Publication
(10) Pub. No.: US 2025/0117441 A1
(43) Pub. Date: Apr. 10, 2025

(54) CONVOLUTION OPERATIONS WITH IN-MEMORY COMPUTING

(71) Applicant: Rain Neuromorphics Inc., San Francisco, CA (US)

(72) Inventors: Nawab Ali, Bellingham, WA (US); Hamid Reza Ghasemi, Sunnyvale, CA (US); Cagri Eryilmaz, San Francisco, CA (US); Andrew John Gill, Lawrence, KS (US); Muzaffer Kal, Redmond, WA (US); Alexander Almela Conklin, San Jose, CA (US)

(21) Appl. No.: 18/906,931

(22) Filed: Oct. 4, 2024

Related U.S. Application Data
(60) Provisional application No. 63/542,732, filed on Oct. 5, 2023.
(60) Provisional application No. 63/546,150, filed on Oct. 27, 2023.

(51) Int. Cl. G06F 17/16; G06F 15/80

(52) U.S. Cl. CPC G06F 17/16; G06F 15/80

(57) ABSTRACT

A method for performing a convolution is described. The method includes providing an activation to a general purpose (GP) processor. The GP processor is coupled with compute engines. Each of the compute engines includes a compute-in-memory (CIM) hardware module. The CIM hardware module stores weights corresponding to a kernel and is configured to perform vector-matrix multiplications (VMMs) for the kernel. The method also includes performing, by the GP processor or at least one of the compute engines, a quantization of the activation to provide a quantized activation. The compute engine(s) perform the VMMs for the quantized activation and the kernel to provide a product. Dequantization of the product is performed by the GP processor or the compute engine(s).

### CROSS REFERENCE TO OTHER APPLICATIONS

This application claims priority to U.S. Provisional Patent Application No. 63/542,732 entitled CONVOLUTION OPERATIONS WITH IN-MEMORY COMPUTING filed Oct. 5, 2023 and U.S. Provisional Patent Application No. 63/546,150 entitled FREQUENCY ADJUSTMENT OF COMPUTE ELEMENTS IN AN ARTIFICIAL INTELLIGENCE ACCELERATOR filed Oct. 27, 2023, both of which are incorporated herein by reference for all purposes.

### BACKGROUND OF THE INVENTION

Artificial intelligence (AI), or machine learning, utilizes learning networks (e.g. deep neural networks) loosely inspired by the brain in order to solve problems. Learning networks typically include layers of weights that weight signals (mimicking synapses) and activation layers that apply activation functions to the signals (mimicking neurons). In some cases, weight layers are interleaved with activation layers. Thus, a weight layer may receive an input signal (also termed an activation), apply the weights, and provide weighted input signals to an activation layer. Neurons in the activation layer operate on the weighted input signals by applying some activation function to the weighted input signals and provide output signals corresponding to the statuses of the neurons. The output signals from the activation layer may be provided as input signals (new activations) to a next weight layer, if any. This process may be repeated for the layers of the network. Learning networks are thus able to reduce complex problems to a set of weights and the applied activation functions. The structure of the network (e.g., number of layers, connectivity among the layers, dimensionality of the layers, the type of activation function, etc.) are together known as a model. Learning networks can leverage hardware, such as graphics processing units (GPUs) and/or AI accelerators, which perform operations usable in machine learning in parallel. Such tools can dramatically improve the speed and efficiency with which data-heavy and other tasks can be accomplished by the learning network.

Convolution operations may be used by learning networks (e.g. convolutional neural networks) for tasks such as image classification. A convolution can be viewed as sliding a tensor, termed a filter or kernel, over a larger input tensor, or activation (e.g. an image tensor). At selected locations, portions of the input tensor are combined with the kernel to produce an output tensor indicating the features in the image tensor. The kernel is smaller than the input tensor and contains weights that may be trained. At a particular position over the image data, the elements of the kernel are multiplied by the corresponding element of the input image and the resulting products summed. Thus, the output is analogous to a dot product. The kernel moves a stride (e.g. a number of pixels or elements of the tensor) to a next position and the process repeated until the convolution is completed for the input tensor. The convolution may be performed using nested loops of operations or by flattening and reshaping the tensors using, e.g., image-to-column (im2col) operations and applying matrix multiplications. Activation functions may be applied and the output may be passed to the next layer for another convolution to be performed.

Although convolutions may be useful for certain tasks, performing a convolution may be inefficient. For example, the use of nested loops to calculate the dot products may be time-consuming. Use of an AI accelerator may reduce the time required for the machine learning model to provide a solution. However, further improvements are desired. In addition, convolutional networks (learning networks implementing convolutions) typically have multiple layers that perform convolutions. Each of these layers may differ. For example, the size of the kernel and/or the input tensor (or activation) may be different for different layers. These differences may adversely impact efficiency of the learning network. Accordingly, what is desired is an improved technique for performing convolutions using learning networks.

### BRIEF DESCRIPTION OF THE DRAWINGS

Various embodiments of the invention are disclosed in the following detailed description and the accompanying drawings.

FIG. 1 is a diagram depicting an embodiment of a system capable of performing convolutions and usable in an AI accelerator.

FIG. 2 depicts an embodiment of a portion of a compute engine usable in an AI accelerator.

FIG. 3 depicts an embodiment of a portion of a compute engine usable in an AI accelerator and capable of performing local updates.

FIG. 4 depicts an embodiment of a portion of a compute-in-memory module usable in an AI accelerator. (SRAM)

FIG. 5 depicts an embodiment of a portion of a compute-in-memory module usable in an AI accelerator. (SRAM)

FIGS. 6A-6B are flow charts depicting embodiments of methods for providing weights for convolutions and for performing convolutions using the weights.

FIG. 7 is a flow chart depicting an embodiment of a method for performing convolutions.

FIG. 8 is a flow chart depicting an embodiment of a method for more efficiently performing convolutions.

FIG. 9 depicts an embodiment of an architecture including compute engines and usable in an AI accelerator that may efficiently perform convolutions.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method for performing a convolution is described. The method includes providing an activation to a general purpose (GP) processor. The GP processor is coupled with compute engines. Each of the compute engines includes a compute-in-memory (CIM) hardware module. The CIM hardware module stores weights corresponding to a kernel and is configured to perform vector-matrix multiplications (VMMs) for the kernel. The method also includes performing, by the GP processor or at least one of the compute engines, a quantization of the activation to provide a quantized activation. The compute engine(s) perform the VMMs for the quantized activation and the kernel to provide a product. Dequantization of the product is performed by the GP processor or the compute engine(s).

In some embodiments, the GP processor performs the quantization of the activation and provides the quantized activation to the compute engine(s). Performing the quantization may further include providing, to a vector register file of the GP processor, the activation. A vector processing unit of the GP processor performs the quantization. The quantized activation is written back to the vector register file of the GP processor. In other embodiments, the compute engine(s) perform the quantization. In such embodiments, the GP processor provides an unquantized activation to the compute engine. In some embodiments, the method may also include storing the activation in an on-tile memory. The activation may be an image-to-column transformed activation. The on-tile memory may be a static random access (SRAM) memory.

In some embodiments, the GP processor is configured to set a clock frequency in the compute engine(s) based on a number of VMMs performed by the compute engine. Setting the clock frequency further includes setting multiple bits. A combination of values of the bits corresponds to the clock frequency of multiple possible clock frequencies.

A compute tile is described. The compute tile includes compute engines and a GP processor coupled with the compute engines. Each compute engine includes a CIM hardware module that stores weights corresponding to a matrix and that is configured to perform VMMs for the matrix. The matrix corresponds to a kernel for a convolution. The GP processor is configured to provide control instructions and data to the compute engines. The GP processor is further configured to receive an activation. The GP processor or at least one of the compute engines is configured to perform a quantization of the activation to provide a quantized activation. The compute engine(s) are configured to perform the VMMs for the kernel and the quantized activation to provide a product. The GP processor or the compute engine(s) are further configured to perform a dequantization of the product.

In some embodiments, the GP processor performs the quantization of the activation and provides the quantized activation to the compute engine(s). Performing the quantization may further include providing, to a vector register file of the GP processor, the activation. A vector processing unit of the GP processor performs the quantization. The quantized activation is written back to the vector register file of the GP processor. In other embodiments, the compute engine(s) perform the quantization. In such embodiments, the GP processor provides an unquantized activation to the compute engine. In some embodiments, the method may also include storing the activation in an on-tile memory. The activation may be an image-to-column transformed activation. The on-tile memory may be a static random access (SRAM) memory.

In some embodiments, the GP processor is configured to set a clock frequency in the compute engine(s) based on a number of VMMs performed by the compute engine. Setting the clock frequency further includes setting multiple bits. A combination of values of the bits corresponds to the clock frequency of multiple possible clock frequencies.

A system including multiple compute tiles is described. Each of the compute tiles includes compute engines and a GP processor coupled with the compute engines. Each compute engine includes a CIM hardware module that stores weights corresponding to a matrix and that is configured to perform VMMs for the matrix. The matrix corresponds to a kernel for a convolution. The GP processor is configured to provide control instructions and data to the compute engines. The GP processor is further configured to receive an activation. The GP processor or at least one of the compute engines is configured to perform a quantization of the activation to provide a quantized activation. The compute engine(s) are configured to perform the VMMs for the kernel and the quantized activation to provide a product. The GP processor or the compute engine(s) are further configured to perform a dequantization of the product.

In some embodiments, the GP processor performs the quantization of the activation and provides the quantized activation to the compute engine(s). Performing the quantization may further include providing, to a vector register file of the GP processor, the activation. A vector processing unit of the GP processor performs the quantization. The quantized activation is written back to the vector register file of the GP processor. In other embodiments, the compute engine(s) perform the quantization. In such embodiments, the GP processor provides an unquantized activation to the compute engine. In some embodiments, the method may also include storing the activation in an on-tile memory. The activation may be an image-to-column transformed activation. The on-tile memory may be a static random access (SRAM) memory.

In some embodiments, the GP processor is configured to set a clock frequency in the compute engine(s) based on a number of VMMs performed by the compute engine. Setting the clock frequency further includes setting multiple bits. A combination of values of the bits corresponds to the clock frequency of multiple possible clock frequencies.

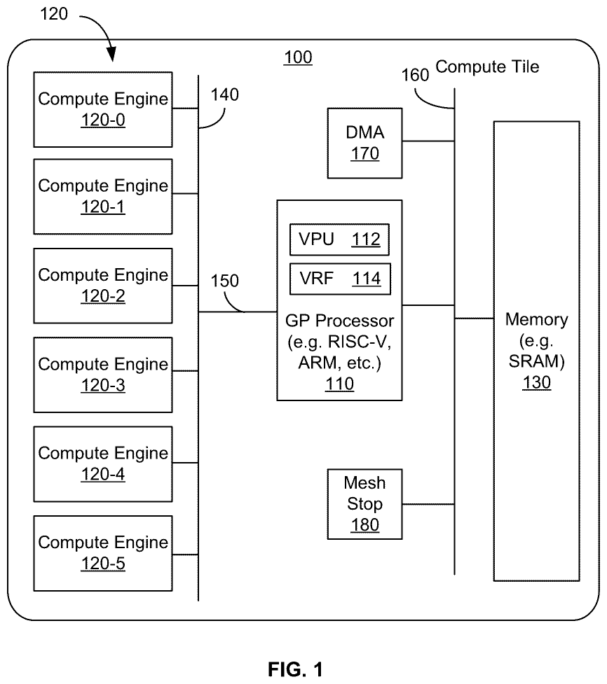

FIG. 1 is a diagram depicting an embodiment of system 100 usable in a learning network. System 100 is a compute tile and may be considered to be an artificial intelligence (AI) accelerator having an efficient architecture. Compute tile (or simply “tile”) 100 may be implemented as a single integrated circuit. Compute tile 100 includes a general purpose (GP) processor 110, compute engines 120-0 through 120-5 (collectively or generically compute engines 120), on-tile memory 130, direct memory access (DMA) 170, and mesh stop 180. Although six compute engines 120 are shown, in other embodiments another number may be included. GP processor 110 is shown as being coupled with compute engines 120 via compute bus (or other connector) 140, and bus 150. In other embodiments, GP processor 110 may be connected with compute engines 120 in another manner. In some embodiments, compute tile 100 may include on-tile memory 130. In other embodiments, memory 130 may be omitted. In some embodiments, DMA 170 and/or mesh stop 180 may be omitted. Other components, for example a cache or another additional memory, module(s) for applying activation functions, modules for moving data, and/or other modules, may be present in compute tile 100 in some embodiments.

DMA 170 initiates data movement for compute tile 100. DMA 170 may be used to move data from off-tile to on-tile and vice-versa. Thus, DMA 170 may be used to communicate with a host (not shown) and/or other tiles (not shown in FIG. 1). For example, DMA 170 may be used to move input vectors (activations) from the host or another tile (not shown in FIG. 1) to memory 130. DMA 170 may also be used to move data within compute tile 100. As used herein, a vector includes not only a 1×n or n×1 matrix, but also m×n matrices, where m and n are both greater than 1. Thus, the terms vector and matrix may be used interchangeably herein. If memory 130 is also directly connected to compute engines 120 (e.g. via compute bus 140), then DMA 170 may be used to move data between memory 130 and compute engines 120. Mesh stop 180 provides an interface between compute tile 100 and the fabric of a mesh network that includes compute tile 100. Thus, mesh stop 180 may be used to communicate with other compute tiles (not shown) with which compute tile 100 may be used. Data may also be moved via bus 160. In some embodiments, therefore, data may be moved to and/or from memory 130 as well as to and/or from tile 100 via buses such as bus 160. In some embodiments, DMA 170 may be configured such that the data stored in on-tile memory 130 is reshaped or otherwise processed. For example, an image-to-column (im2col) transformation may be applied such that a three (or more) dimensional tensor is stored as a two-dimensional matrix in on-tile memory 130.

GP processor 110 is a reduced instruction set computer (RISC) processor. For example, GP processor 110 may be a RISC-V processor or ARM processor. In other embodiments, different and/or additional general purpose processor(s) may be used. The GP processor 110 provides control instructions and data to the compute engines 120. GP processor 110 implements instruction set(s) used in controlling compute engines 120. GP processor 110 provides the commands to compute engines 120 and controls data movement to and/or from compute engines 120. GP processor 110 may thus function as part of a control plane for (i.e. providing commands and being part of the data path) compute engines 120 and tile 100.

In some embodiments, data is moved from memory 130 or another source to compute engine(s) 120 through GP processor 110. Data may be sent from memory 130 to internal memory of GP processor 110, and then to the appropriate compute engine(s) 120 via buses 140 and 150. For example, data from memory 130 may be provided to a vector register file (not shown) of GP processor 110 and then provided from GP processor 110 to the appropriate compute engine(s) 120. Once compute engines 120 have performed their functions, the output is provided to GP processor 110. Similarly, data may be moved from compute engines 120 to memory 130 or another destination via GP processor 110. Thus, GP processor 110 may be part of both the control plane and data plane for compute tile 100.

GP processor 110 may also perform other functions. GP processor 110 may apply activation function(s) to data. For example, an activation function (e.g. a ReLu, Tanh, and/or SoftMax) may be applied to the output of compute engine(s) 120. Thus, GP processor 110 may perform nonlinear operations. GP processor 110 may also perform linear functions and/or other operations. However, GP processor 110 is still desired to have reduced functionality as compared to, for example, a graphics processing unit (GPU) or central processing unit (CPU) of a computer system with which tile 100 might be used.

GP processor 110 is also shown as including vector processing unit (VPU) 112 and vector register file (VRF) 114. VRF 114 may be used to store data that is to be transferred to or from compute engines 120. In some embodiments, VRF 114 may be used to store data on which various operations may be performed. For example, VRF 114 may be used to store activations (e.g. matrices or vectors) and/or weights (e.g. for a kernel) to which operations such as activation functions, quantization, and/or dequantization may be applied. VPU 112 may be used to perform at least some of the operations on the contents of VRF 114. For example, VPU 112 may apply activation functions, such as ReLu, Tanh, SoftMax, and/or Sigmoid. In addition, VPU 112 may be used to quantize and/or dequantize activations and/or weights stored in VRF 114. For example, VPU 112 may be used to convert between integer format (e.g. Int8) and floating point format (e.g. BF16). In some embodiments, a separate unit may be provided in GP processor 110 to perform functions such as quantization. In such embodiments, quantization and dequantization may be performed while freeing VPU 112 to execute other functions. In some embodiments, GP processor 110 may also perform other operations, such as im2col conversions using VPU 112 and VRF 114. As such, GP processor 110 may facilitate convolution operations.

Compute engines 120 are configured to perform, efficiently and in parallel, tasks that may be part of using (e.g. performing inferences) and/or training (e.g. performing inferences and/or updating weights) a model. Compute engines 120 are coupled with and receive commands and, in at least some embodiments, data from GP processor 110. Compute engines 120 are modules which perform vector-matrix multiplications (VMMs) in parallel. Thus, compute engines 120 may perform linear operations. Each compute engine 120 includes a compute-in-memory (CIM) hardware module (not specifically shown in FIG. 1). The CIM hardware module stores weights corresponding to a matrix and is configured to perform a VMM in parallel for the matrix. Compute engines 120 may also include local update (LU) module(s) (not specifically shown in FIG. 1). Such LU module(s) allow compute engines 120 to update weights stored in the CIM module.

The CIM module is a hardware module that stores data and performs operations. In some embodiments, CIM module stores weights for the model, or for the kernel(s) used in convolutions. As such, the CIM module determines the maximum size of the model that can be handled by compute tile 100 (i.e. the maximum number of parameters, or weights). The CIM module stores the weights (or other data) in cells that are fully addressable. The CIM module also performs operations using the weights. More specifically, the CIM module performs VMMs, where the vector may be an input vector/matrix (e.g. an activation) provided using GP processor 110 and the matrix may be weights (i.e. data/parameters/the kernel) stored by the CIM module. The CIM module may be considered to include a memory (e.g. that stores the weights) and compute hardware (e.g. that performs the matrix multiplication of the stored weights). In some embodiments, the activation may be a matrix. The CIM module may include an analog SRAM having multiple SRAM cells and configured to provide output(s) (e.g. voltage(s)) corresponding to the data (weight/parameter) stored in each cell of the SRAM multiplied by a corresponding element of the input vector, or matrix. In some embodiments, the CIM module may include a digital SRAM having multiple SRAM cells and configured to provide output(s) corresponding to the data (weight/parameter) stored in each cell of the digital SRAM multiplied by a corresponding element of the input matrix. Other configurations of CIM modules are possible. Each CIM module thus stores weights corresponding to a matrix in its cells and is configured to perform a matrix multiplication of the matrix with an input activation. In some embodiments, the CIM module of a compute engine 120 may be repurposed as memory if the compute engine utilization falls below a particular threshold (e.g. 70%-80%). For example, the CIM might store duplicate weights or vectors/matrices (e.g. activations) in such embodiments.

In order to facilitate on-chip learning, local update (LU) modules (not shown) may also be provided in compute engines 120. LU modules are coupled with the corresponding CIM modules. LU modules are used to update the weights (or other data) stored in the CIM modules. LU modules are considered local because LU modules are in proximity to CIM modules. For example, LU module(s) for a particular compute engine 120 may reside in the same integrated circuit as the CIM module(s) for compute engine 120. In some embodiments, the LU module is considered local because it is fabricated on the same substrate (e.g. the same silicon wafer) as the corresponding CIM module. In some embodiments, LU modules are also used in determining the weight updates. In other embodiments, a separate component may calculate the weight updates. For example, in addition to or in lieu of LU modules, the weight updates may be determined by GP processor 110, in software by other processor(s) not part of compute tile 100, by other hardware that is part of compute tile 100, by other hardware outside of compute tile 100, and/or some combination thereof.

Memory 130 may be or include a static random access memory (SRAM) and/or some other type of memory. In some embodiments, memory 130 may be or include other memories, including but not limited to dynamic random access memory (DRAM) and/or hybrid memories. Memory 130 is shown as coupled with GP processor 110. Stated differently, data movement between memory 130 and compute engines 120 may take place via GP processor 120. In some embodiments, memory 130 may be coupled to compute bus 140 (i.e. to compute engines 120). Memory 130 may store activations (e.g. input vectors provided to compute tile 100 and the resultant of activation functions applied to the output of compute engines 120). Memory 130 may also store weights. For example, memory 130 may contain a backup copy of the weights or different weights if the weights stored in compute engines 120 are desired to be changed. In some embodiments, memory 130 is organized into banks of cells (e.g. banks of SRAM cells). In such embodiments, specific banks of memory 130 may service specific one(s) of compute engines 120. In other embodiments, banks of memory 130 may service any compute engine 120.

In operation, an input activation (e.g. a vector/matrix) is provided to one or more of compute engines 120 by GP processor 110. The input activation is desired to be multiplied by the weights, or kernel, which may have been previously stored in compute engine(s) 120. The input activation may be provided to multiple compute engines 120 if the kernel and/or input activation have too many elements for a single compute engine. In some such embodiments, a portion of the input activation is provided to each of the multiple compute engines 120 (each of which stores a portion of the weight(s)/kernel). In some embodiments, the input activation is provided, as a set of vectors, from memory 130 to GP processor 110 and from GP processor 110 to compute engine(s) 120. GP processor 110 and/or compute engine(s) 120 may also perform additional processing of the data before a VMM is performed. For example, GP processor 110 and/or compute engine(s) 120 may perform quantization and/or other operations such as im2col or flattening of the data in advance of VMMs. GP processor 110 also instructs compute engine(s) 120 to perform VMMs.

Compute engine(s) 120 perform VMMs between the vectors of the input activation and the matrix of weights of the kernel to provide an output. The output may be considered a dot product between the kernel and the activation. The VMMs are performed in parallel for the elements of the input activation. The output is provided by compute engine(s) 120 to GP processor 110. For example, the output may be stored in VRF 114 of GP processor 110. GP processor 110 and/or compute engine(s) 120 may also perform additional processing of the output product of the VMM. For example, GP processor 110 and/or compute engine(s) 120 may perform dequantization of the output product. GP processor 110 may also store the output in memory 130 and/or may provide the output to another component off-tile. GP processor 110 may apply a function (e.g. an activation function) to the output product. The results of the activation function applied to the output of compute engines 120 may be stored in GP processor 110 (e.g. in a buffer or VRF 114). GP processor 110 may also store the results in memory 130 or off-tile. GP processor 110 may provide the results as an input activation to other compute engine(s) 120 to apply a different set of weights (e.g. another kernel) to the results. Thus, one or more inferences with one or more distinct sets of weights or one or more convolutions with different kernels may be performed. In some embodiments, training may also be performed by tile 100. In some such embodiments, GP processor 110 or another component (such as a host) may determine the desired update for the weights. In some embodiments, LU module (not shown) of compute engines 120 may be used to determine and apply the updates to the weights.

Thus, compute tile 100 includes two compute blocks, GP processor 110 and compute engines 120, which work together. GP processor 110 and compute engines 120 are, therefore, tightly coupled. GP processor 110 may perform nonlinear operations (e.g. activation functions) and compute engines 120 may perform linear operations (e.g. VMMs). GP processor 110 is in the control and data planes for compute engines 120. For convolutions, the GP processor 110 and/or the compute engine(s) 120 may perform functions such as quantization or im2col operations. Consequently, data may be moved more efficiently within tile 100. Operations, such as VMMs, quantizations/dequantizations, and the application of activation functions to the output of compute engines 120, may be more efficiently performed. Further, a special purpose controller need not be designed and fabricated for compute tile 100. Instead, GP processor 110 is used. As a result, compute tile 100 may be more flexible and more readily designed and fabricated. For example, the activation applied by GP processor 110 may be updated by updating GP processor 110. A new special purpose controller need not be provided. Consequently, functions for machine learning may be more efficiently and readily performed. In addition, compute tile 100 includes on-tile memory 130. Use of on-tile memory, for example as a scratchpad memory, allows for a high degree of independence of compute tile 100 from other components (e.g. other tiles). Thus, multiple tiles 100 may more readily work in parallel. Consequently, efficiency of learning may be enhanced.

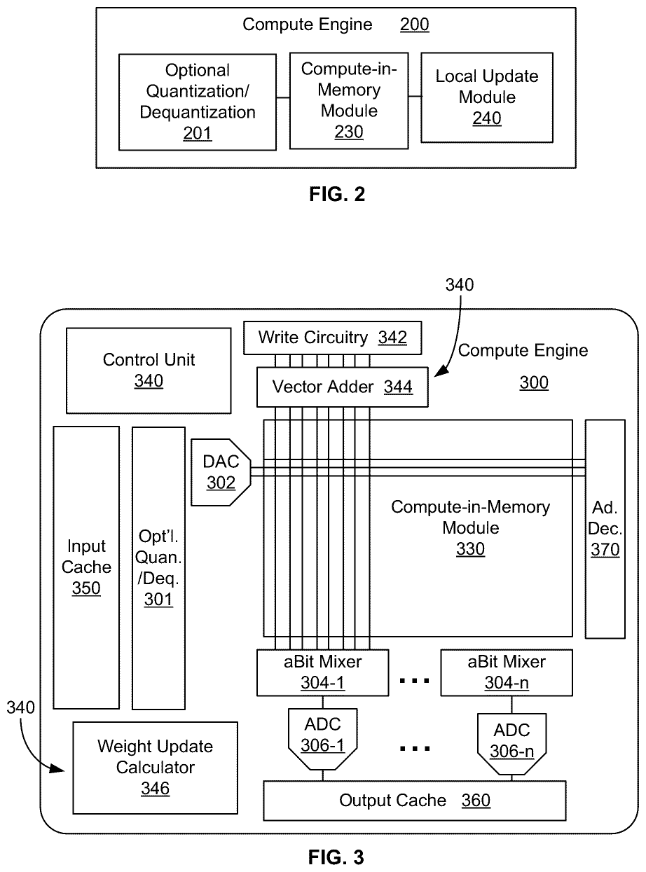

FIG. 2 depicts compute engine 200 usable in an AI accelerator that may perform convolutions. Compute engine 200 may be part of an AI accelerator that can be deployed for using a model (not explicitly depicted) and for allowing for on-chip training of the model (otherwise known as on-chip learning). Compute engine 200 may thus be used as compute engine(s) 120, 220, and/or 320. Compute engine 200 includes optional quantization/dequantization (Q/Deq) module 201, CIM module 230, and LU module 240. Although one CIM module 230 and one LU module 240 is shown, a compute engine may include another number of CIM modules 230 and/or another number of LU modules 240. For example, a compute engine might include three CIM modules 230 and one LU module 240, one CIM module 230 and two LU modules 240, or two CIM modules 230 and two LU modules 240. Q/Deq module 201 may be omitted in some embodiments.

Q/Deq module 201 may be used instead of or in addition to GP processor 110 to perform quantizations of weights and/or activations. Q/Deq module 201 may also perform dequantizations, for example of weights, activation, and/or a dot product of the activation. In some embodiments Q/Deq module 201 may be omitted.

CIM module 230 is a hardware module that stores data and performs operations. In some embodiments, CIM module 230 stores weights for the model or kernel. CIM module 230 also performs operations using the weights. More specifically, CIM module 230 performs vector-matrix multiplications, where the vector may be an input vector provided using processor 110 and the matrix may be weights (i.e. data/parameters) stored by CIM module 230. Thus, CIM module 230 may be considered to include a memory (e.g. that stores the weights, e.g. for the kernel) and compute hardware (e.g. that performs the vector-matrix multiplication of the stored weights). In some embodiments, the vector may be a matrix (i.e. an n×m vector where n>1 and m>1). For example, CIM module 230 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM module 230 may include a digital static SRAM having multiple SRAM cells and configured to provide output(s) corresponding to the data (weight/parameter) stored in each cell of the digital SRAM multiplied by a corresponding element of the input vector. In some embodiments, CIM module 230 may include an analog resistive random access memory (RAM) configured to provide output (e.g. voltage(s)) corresponding to the impedance of each cell multiplied by the corresponding element of the input vector. Other configurations of CIM module 330 are possible. Each CIM module 230 thus stores weights corresponding to a matrix in its cells and is configured to perform a vector-matrix multiplication of the matrix with an input vector.

In order to facilitate on-chip learning, LU module 240 may be provided. LU module 240 is coupled with the corresponding CIM module 230. LU module 240 is used to update the weights (or other data) stored in CIM module 230. LU module 240 is considered local because LU module 240 is in proximity with CIM module 230. For example, LU module 240 may reside on the same integrated circuit as CIM module 230. In some embodiments LU module 240 for a particular compute engine resides in the same integrated circuit as the CIM module 230. In some embodiments, LU module 240 is considered local because it is fabricated on the same substrate (e.g. the same silicon wafer) as the corresponding CIM module 230. In some embodiments, LU module 240 is also used in determining the weight updates. In other embodiments, a separate component may calculate the weight updates. For example, in addition to or in lieu of LU module 240, the weight updates may be determined by a GP processor, in software by other processor(s) not part of compute engine 200 and/or the corresponding AI accelerator (e.g. compute tile 100), by other hardware that is part of compute engine 200 and/or the corresponding AI accelerator (e.g. compute tile 100, 200, or 300), by other hardware outside of compute engine 200 or the corresponding AI accelerator (e.g. compute tile 100, 200, or 300), and/or some combination thereof.

Using compute engine 200 in the context of compute tile 100 and/or an analogous system, efficiency and performance of a learning network may be improved. Use of CIM modules 230 may dramatically reduce the time to perform the vector-matrix multiplication that provides the weighted signal. Thus, performing inference(s) using compute engine 200 may require less time and power. This may improve efficiency of training and use of the model. LU modules 240 allow for local updates to the weights in CIM modules 230. This may reduce the data movement that may otherwise be required for weight updates. Consequently, the time taken for training may be greatly reduced. In some embodiments, the time taken for a weight update using LU modules 240 may be an order of magnitude less (i.e. require one-tenth the time) than if updates are not performed locally. Efficiency and performance of a learning network provided using system 100 may be increased.

FIG. 3 depicts an embodiment of compute engine 300 usable in an AI accelerator that performs convolutions and is capable of performing local updates. Compute engine 300 may be a hardware compute engine analogous to compute engine 200. Compute engine 300 thus includes Q/Deq module 301, CIM module 330 and LU module 340 analogous to CIM modules 230 and LU modules 240, respectively. Compute engine 300 also includes analog bit mixer (aBit mixer) 304-1 through 304-n (generically or collectively 304), analog to digital converter(s) (ADC(s)) 306-1 through 306-n (generically or collectively 306), input cache 350, output cache 360, and address decoder 370. Although particular numbers of components 302, 304, 306, 330, 340, 342, 344, 346, 360, and 370 are shown, another number of one or more components 302, 304, 306, 330, 340, 342, 344, 346, 360, and 370 may be present. Further, in some embodiments some components may be omitted. for example, ADC(s) 306 and/or DAC(s) 302 may be omitted.

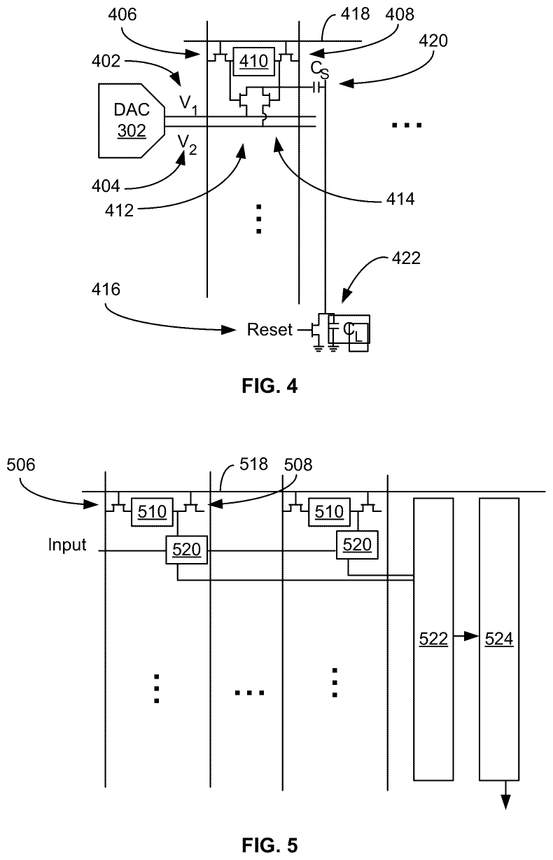

CIM module 330 is a hardware module that stores data corresponding to weights and performs vector-matrix multiplications. The vector is an input vector provided to CIM module 330 (e.g. via input cache 350) and the matrix includes the weights stored by CIM module 330. In some embodiments, the vector may be a matrix. Examples of embodiments CIM modules that may be used in CIM module 330 are depicted in FIGS. 4 and 5.

FIG. 4 depicts an embodiment of a cell in one embodiment of an SRAM CIM module usable for CIM module 330. Also shown is DAC 302 of compute engine 300. For clarity, only one SRAM cell 410 is shown. However, multiple SRAM cells 410 may be present. For example, multiple SRAM cells 410 may be arranged in a rectangular array. An SRAM cell 410 may store a weight or a part of the weight. The CIM module shown includes lines 402, 404, and 418, transistors 406, 408, 412, 414, and 416, capacitors 420 (C_{S}) and 422 (C_{L}). In the embodiment shown in FIG. 4, DAC 302 converts a digital input voltage to differential voltages, V₁ and V₂, with zero reference. These voltages are coupled to each cell within the row. DAC 302 is thus used to temporal code differentially. Lines 402 and 404 carry voltages V₁ and V₂, respectively, from DAC 302. Line 418 is coupled with address decoder 370 (not shown in FIG. 4) and used to select cell 410 (and, in the embodiment shown, the entire row including cell 410), via transistors 406 and 408.

In operation, voltages of capacitors 420 and 422 are set to zero, for example via Reset provided to transistor 416. DAC 302 provides the differential voltages on lines 402 and 404, and the address decoder (not shown in FIG. 4) selects the row of cell 410 via line 418. Transistor 412 passes input voltage V₁ if SRAM cell 410 stores a logical 1, while transistor 414 passes input voltage V₂ if SRAM cell 410 stores a zero. Consequently, capacitor 420 is provided with the appropriate voltage based on the contents of SRAM cell 410. Capacitor 420 is in series with capacitor 422. Thus, capacitors 420 and 422 act as capacitive voltage divider. Each row in the column of SRAM cell 410 contributes to the total voltage corresponding to the voltage passed, the capacitance, C_{S}, of capacitor 420, and the capacitance, C_{L}, of capacitor 422. Each row contributes a corresponding voltage to the capacitor 422. The output voltage is measured across capacitor 422. In some embodiments, this voltage is passed to the corresponding aBit mixer 304 for the column. In some embodiments, capacitors 420 and 422 may be replaced by transistors to act as resistors, creating a resistive voltage divider instead of the capacitive voltage divider. Thus, using the configuration depicted in FIG. 4, CIM module 330 may perform a vector-matrix multiplication using data stored in SRAM cells 410.

FIG. 5 depicts an embodiment of a cell in one embodiment of a digital SRAM module usable for CIM module 330. For clarity, only one digital SRAM cell 510 is labeled. However, multiple cells 510 are present and may be arranged in a rectangular array. Also labeled are corresponding transistors 506 and 508 for each cell, line 518, logic gates 520, adder tree 522 and digital mixer 524. Because the SRAM module shown in FIG. 5 is digital, DACs 302, aBit mixers 304, and ADCs 306 may be omitted from compute engine 300 depicted in FIG. 3.

In operation, a row including digital SRAM cell 510 is enabled by address decoder 370 (not shown in FIG. 5) using line 518. Transistors 506 and 508 are enabled, allowing the data stored in digital SRAM cell 510 to be provided to logic gates 520. Logic gates 520 combine the data stored in digital SRAM cell 510 with the input vector. Thus, the binary weights stored in digital SRAM cells 510 are combined with the binary inputs. The output of logic gates 520 are accumulated in adder tree 522 and combined by digital mixer 524. Thus, using the configuration depicted in FIG. 5, CIM module 330 may perform a vector-matrix multiplication using data stored in digital SRAM cells 510.

Referring back to FIG. 3, CIM module 330 thus stores weights corresponding to a matrix in its cells and is configured to perform a vector-matrix multiplication of the matrix with an input vector. In some embodiments, compute engine 300 stores positive weights in CIM module 330. However, the use of both positive and negative weights may be desired for some models and/or some applications. In such cases, bipolar weights (e.g. having range −S through +S) are mapped to a positive range (e.g. 0 through S). For example, a matrix of bipolar weights, W, may be mapped to a positive weight matrix Wₚ such that: Wx=(Wₚ−SJ/2)(2x)=3Wₚx−SΣᵢxᵢ. where J is a matrix of all ones having the same size as W and S is the maximum value of the weight (e.g. 2^{N-1}−1 for an N-bit weight). For simplicity, compute engine 300 is generally discussed in the context of CIM module 330 being an analog SRAM CIM module analogous to that depicted in FIG. 4.

Input cache 350 receives an input vector for which a vector-matrix multiplication is desired to be performed. In some embodiments, the input vector is provided to input cache by a GP processor, such as GP processor 110. The input vector may be read from a memory, from a cache or register in the processor, or obtained in another manner. The input from compute engine 110 may be quantized using Q/Deq 301. Digital-to-analog converter (DAC) 302 converts a digital input vector to analog in order for CIM module 330 to operate on the vector. Although shown as connected to only some portions of CIM module 330, DAC 302 may be connected to all of the cells of CIM module 330. Alternatively, multiple DACs 302 may be used to connect to all cells of CIM module 330. Address decoder 370 includes address circuitry configured to selectively couple vector adder 344 and write circuitry 342 with each cell of CIM module 330. Address decoder 370 selects the cells in CIM module 330. For example, address decoder 370 may select individual cells, rows, or columns to be updated, undergo a vector-matrix multiplication, or output the results. In some embodiments, aBit mixer 304 combines the results from CIM module 330. Use of aBit mixer 304 may save on ADCs 306 and allows access to analog output voltages.

ADC(s) 306 convert the analog resultant of the vector-matrix multiplication to digital form. Output cache 360 receives the result of the vector-matrix multiplication and outputs the result from compute engine 300. Thus, a vector-matrix multiplication may be performed using CIM module 330.

LU module 340 includes write circuitry 342 and vector adder 344. In some embodiments, LU module 340 includes weight update calculator 346. In other embodiments, weight update calculator 346 may be a separate component and/or may not reside within compute engine 300. Weigh update calculator 346 is used to determine how to update to the weights stored in CIM module 330. In some embodiments, the updates are determined sequentially based upon target outputs for the learning system of which compute engine 300 is a part. In some embodiments, the weight update provided may be sign-based (e.g. increments for a positive sign in the gradient of the loss function and decrements for a negative sign in the gradient of the loss function). In some embodiments, the weight update may be ternary (e.g. increments for a positive sign in the gradient of the loss function, decrements for a negative sign in the gradient of the loss function, and leaves the weight unchanged for a zero gradient of the loss function). Other types of weight updates may be possible. In some embodiments, weight update calculator 346 provides an update signal indicating how each weight is to be updated. The weight stored in a cell of CIM module 330 is sensed and is increased, decreased, or left unchanged based on the update signal. In particular, the weight update may be provided to vector adder 344, which also reads the weight of a cell in CIM module 330. More specifically, adder 344 is configured to be selectively coupled with each cell of CIM module by address decoder 370. Vector adder 344 receives a weight update and adds the weight update with a weight for each cell. Thus, the sum of the weight update and the weight is determined. The resulting sum (i.e. the updated weight) is provided to write circuitry 342. Write circuitry 342 is coupled with vector adder 344 and the cells of CIM module 330. Write circuitry 342 writes the sum of the weight and the weight update to each cell. In some embodiments, LU module 340 further includes a local batched weight update calculator (not shown in FIG. 3) coupled with vector adder 344. Such a batched weight update calculator is configured to determine the weight update.

Compute engine 300 may also include control unit 340. Control unit 340 generates the control signals depending on the operation mode of compute engine 300. Control unit 340 is configured to provide control signals to CIM hardware module 330 and LU module 349. Some of the control signals correspond to an inference mode. Some of the control signals correspond to a training, or weight update mode. In some embodiments, the mode is controlled by a control processor (not shown in FIG. 3, but analogous to processor 110) that generates control signals based on the Instruction Set Architecture (ISA).

In inference mode, the input data is multiplied by the stored weights and output is obtained after ADC 306. This mode may include many steps. For example, if capacitors arranged in a voltage divider are used to provide the output (e.g. in FIG. 4), the capacitors (or other storage elements) may be reset. For example, capacitors are rest to either zero or certain precharge value depending on the functionality of the capacitor. Capacitive voltage divider operation is enabled to provide the output of the vector-matrix-multiplication. aBit mixer 304 is enabled. ADC(s) 306 are also enabled. Data are stored in output cache 360 to be passed to the compute engine or other desired location(s). This process may be repeated for the entire vector multiplication. In weight update mode, the weight update signals may be generated sequentially by weight update calculator 346. In parallel, cells in a row of CIM module 330 are read row by row and passed to adder 344 for the corresponding weight update.

Using compute engine 300, efficiency and performance of a learning network may be improved. CIM module 330 may dramatically reduce the time to perform the vector-matrix multiplication. Thus, performing inference(s) using compute engine 300 may require less time and power. This may improve efficiency of training and use of the model. LU module 340 uses components 342, 344, and 346 to perform local updates to the weights stored in the cells of CIM module 330. This may reduce the data movement that may otherwise be required for weight updates. Consequently, the time taken for training may be dramatically reduced. Efficiency and performance of a learning network provided using compute engine 300 may be increased.

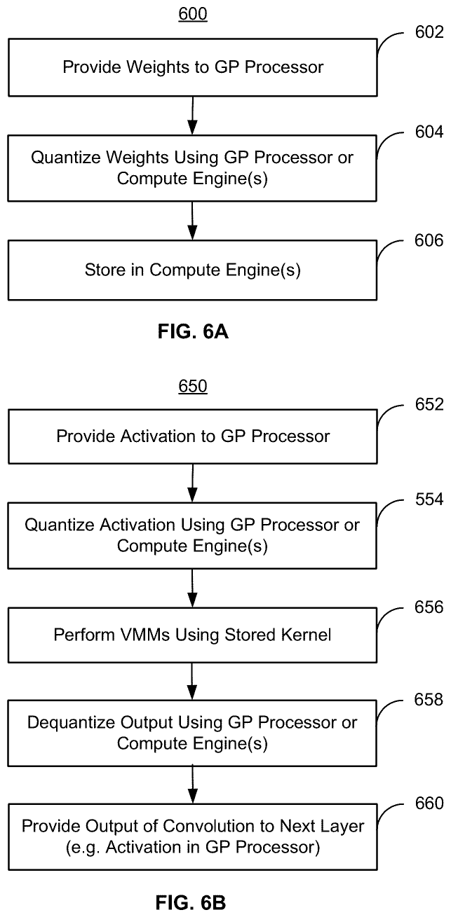

FIGS. 6A-6B are flow charts depicting embodiments of methods for providing weights for convolutions and for performing convolutions using the weights. FIG. 6A depicts method 600 for providing weights (e.g. of a kernel) to compute engines for performing convolutions. FIG. 6B depicts method 650 for performing convolutions using the weights stored in the compute engines. Methods 600 and 650 are described in the context of compute tile 100. However, methods 600 and/or 650 are usable with other compute tiles and/or other compute engines. Although particular processes are shown in an order, the processes may be performed in another order, including in parallel. Further, processes may have substeps.

Referring to FIG. 6A, the weights for one or more convolutions are provided to compute engine(s) using method 600. The weights are provided to a GP processor of the compute tile, at 602. In some embodiments, the weights are provided from an on-tile memory to the GP processor. Because the weights may be part of a tensor, in some embodiments, an operation may previously have been performed such that the weights are stored as a matrix in the on-tile memory. For example, flattening may be used. In some embodiments, the weights may be provided from a memory off-tile. For example, an on-tile memory (e.g. an SRAM) of another tile or DRAM may be the source of the weights provided at 602. In such an embodiment, the weights may be provided via a DMA from the off-tile source to the on-tile memory and from the on-tile memory to the GP processor (or directly to a memory in GP processor). In some embodiments, the weights are provided from the on-tile memory to a VRF in the GP processor.

The weights may be stored in a higher precision format, such as an integer format. Thus, the weights are quantized, at 604. In some embodiments, 604 is performed by the GP processor. In some embodiments, 604 is performed by hardware in the compute engine. Performing 604 in the compute engine may be faster. However, use of the GP processor to perform quantization may reduce the amount of data moved and allow for increased flexibility. The weights are stored in the CIM module of the compute engine at 606. In some embodiments, 602, 604, and 606 are repeated for each kernel for each convolution.

For example, weights may be stored in on-tile memory (e.g. SRAM) 130. At 602, the weights are loaded from on-tile memory 130 to GP processor 110. In some embodiments, the weights are loaded into VRF 114. Using GP processor 110 and/or the compute engine(s) in which the weights are to be stored, the weights may be quantized, at 604. For example, weights that are stored in on-tile memory 130 in BF16 may be converted to Int8. At 606 these weights are stored in the corresponding compute engine(s) 120. For example, the weights may be loaded from GP processor 110 to an input buffer in the appropriate compute engine(s). Thus, kernels may be stored in one or more compute engines of compute tile 100. Compute tile 100 may then utilize the kernels to perform convolutions.

Referring to FIG. 6B, method 650 may utilize the weights in compute engine(s) stored via method 600. However, in some embodiments, weights may be stored in another manner. The activation is provided to the GP processor, at 652. In some embodiments, the activation is provided from an on-tile memory to the GP processor. Because the activation may be a tensor, an operation may previously have been performed such that the activation is stored as a matrix in the on-tile memory. In other embodiments, the GP processor may perform an operation such as an im2col on the activation. In some embodiments, the activation may be provided from a memory off-tile. For example, an on-tile memory (e.g. an SRAM) of another tile or DRAM may be the source of the activation provided at 652. In such an embodiment, the activation may be provided via a DMA from the off-tile source to the on-tile memory and from the on-tile memory to the GP processor (or directly to a memory in GP processor). In some embodiments, the activation is provided from the on-tile memory to a VRF in the GP processor. To do so, the activation may be provided as a series of vectors.

The activation is quantized, at 654. In some embodiments, 654 is performed by the GP processor. In some embodiments, 654 is performed by hardware in the compute engine(s) used to perform the VMMs for the activation and the kernel. Performing 654 in the compute engine may be faster. However, use of the GP processor to perform quantization may reduce the amount of data moved and allow for increased flexibility. The activation is provided to the compute engine(s) storing the appropriate weights and VMMs performed by the compute engine, at 656. The output of the VMMs may be dequantized, at 658. The dequantization may be performed by the compute engine and/or the GP processor. Further, the dequantization can, but need not, be performed by the same component as the quantization. For example, quantization might be performed by the GP processor and dequantization performed in the compute engine(s). However, similar considerations with respect to data movement and speed apply.

The output of the convolution may be provided to the next layer of the learning network, at 660. For example, the GP processor may apply an activation function to the output. The resultant may be stored (e.g. in on-tile memory or in a memory that is off-tile) and/or provided to another set of compute engine(s) for the next layer of convolutions. The output of the compute engine(s) may be provided to other compute engine(s) storing the next kernel for a subsequent convolution. In some cases, 658 (dequantization) may be skipped until the resulting output is to be stored outside of the GP processor and compute engine(s).

For example, compute tile 100 may store one or more kernels in compute engines 120. The activation is provided to GP processor 110, at 652. For some activations, an im2col may be performed by GP processor 110 or the activations may have been stored in on-tile memory 130 as a matrix. Thus, 652 may include the activation being read from memory 130 (e.g. as a series of vectors) and provided to GP processor 110. GP processor 110 or the corresponding compute engines 120 may be used to quantize the activation, at 654. If compute engine(s) 120 perform the quantization, then the unquantized activations are provided from GP processor 110 to compute engine(s) 120 as part of 654. If GP processor 110 performs the quantization, then the quantized activation is provided to compute engine(s) 120 as part of 654. The VMMs for the (two-dimensional quantized) kernel and the (two-dimensional quantized) activation may be performed in parallel by compute engine(s) 120. These VMM may be performed vector-by-vector for portions of the activation. The resulting dot product of the kernel and activation may be dequantized, at 658. Dequantization at 658 may be accomplished by GP processor 110 or the compute engine(s) 120. GP processor 110 may apply the activation function and/or store the resultant in memory 130 or another location. Some or all of method 650 may be performed for the resultant to implement another convolution.

Using methods 600 and 650 convolutions may be more efficiently performed. For example, the benefits described in the context of compute tile 100 may be achieved. The GP processor 110 and/or the compute engine(s) 120 may perform functions such as quantization and/or im2col operations. Consequently, data may be moved more efficiently within tile 100. Operations, such as VMMs, quantizations/dequantizations, convolutions, and the application of activation functions to the output of compute engines 120, may be more efficiently performed. Consequently, performance of a system utilizing method(s) 600 and/or 650 may be improved.

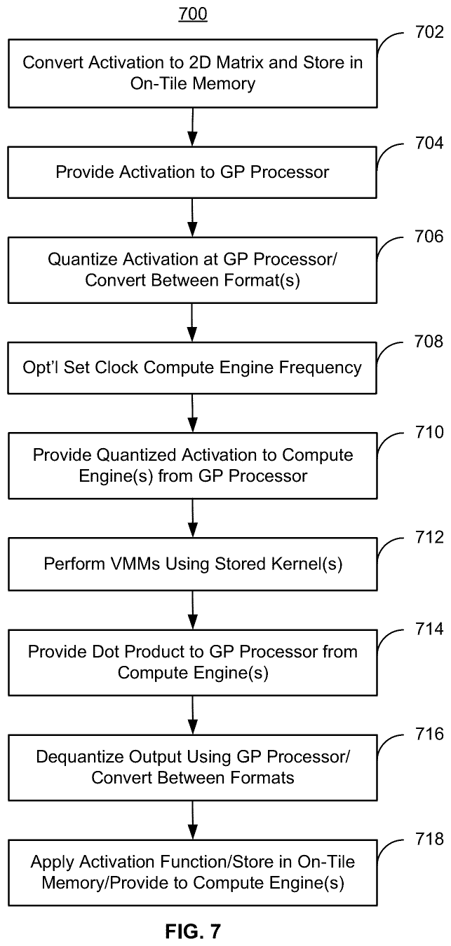

FIG. 7 is a flow chart depicting an embodiment of method 700 for performing convolutions. Method 700 is described in the context of compute tile 100. However, method 700 is usable with other compute tiles and/or other compute engines. Although particular processes are shown in an order, the processes may be performed in another order, including in parallel. Further, processes may have substeps. Method 700 may utilize the weights (e.g. the kernel(s)) in compute engine(s) stored via method 600. However, in some embodiments, weights may be stored in another manner.

The activation is converted to a two-dimensional matrix and stored in on-tile memory 130, at 702. For example, DMA 170 may be used to read activations from off-tile and appropriately store the activation in on-tile memory 130. The activation is provided to GP processor 110, at 704. In some embodiments, the activation is provided from on-tile memory 130. In some embodiments, an operation (e.g. im2col operations) may previously have been performed such that the activation is stored as a matrix in the on-tile memory. Thus, 704 may simply include providing the activation vector-by-vector from on-tile memory 130 to GP processor 110. In some embodiments, the activation is provided to VRF 114 of GP processor 110.

The activation is quantized by GP processor 110, at 706. In some embodiments, 706 is performed using VPU 112 and VRF 114. More specifically, VPU 112 may read the vectors stored in VRF 114 and perform the quantization. For example, VPU 112 may convert BF16 to Int8. Other number formats may be used in other embodiments. In addition, if not already performed at 702, GP processor 110 may also perform an im2col or analogous operation to ensure that compute engines 120 may be used for the convolution.

The clock frequency for the compute engine(s) 120 may be set, at 708. In some embodiments, 708 may be performed at another time. For example, the clock frequencies may be set for the compute engine(s) 120 when the weights are loaded. For compute engines 120 that store kernels requiring larger numbers of VMMs, the frequency may be set higher. For example, 708 may include setting bit(s) for each compute engine 120. The possible combinations of bits correspond to possible frequencies. As a result, the total time for each compute engine 120 to perform its VMMs may be configured. In other embodiments, 708 may be omitted.

The quantized activation is provided from GP processor 110 to the compute engine(s) 120 storing the appropriate weights for the kernel being used for the convolution, at 710. VMMs for each vector of the activation and kernel (i.e. weights) are performed by compute engine(s) 120, at 712. Thus, via 712, the dot product between the kernel and activation may be performed. The resultant of the VMMs is provided from compute engine(s) 120 to GP processor 110, at 714.

The resultant of the VMMs is dequantized by GP processor 110, at 716. For example, if the activation was converted from BF16 to Int8 at 706, then the resultant may be converted from Int8 to BF16 at 716. At 718, further processing is performed. For example, GP processor 110 may apply the activation function and the resultant may be stored in on-tile memory 130 or provided to another compute tile. The resultant may be provided to other compute engines 120 on compute tile 100 that store the kernel for the next convolution. In such embodiments, the resultant may be quantized by GP processor 110 or 716 may be skipped.

Using method 700 convolutions may be more efficiently performed. For example, the benefits described in the context of compute tile 100 may be achieved. The GP processor 110 and/or the compute engine(s) 120 may perform functions such as quantization and/or im2col operations. Consequently, data may be moved more efficiently within tile 100 and flexibility may be improved. For example, the type of quantization used may be updated by updated GP processor 110. Operations, such as VMMs, quantizations/dequantizations, convolutions, and the application of activation functions to the output of compute engines 120, may be more efficiently performed. Setting the clock frequencies for compute engines at 708 may allow the total time for compute engines 120 to complete VMMs to be harmonized. Thus, pipelining of convolutions may be improved. Consequently, performance of a system utilizing method 700 to perform convolutions may be improved.

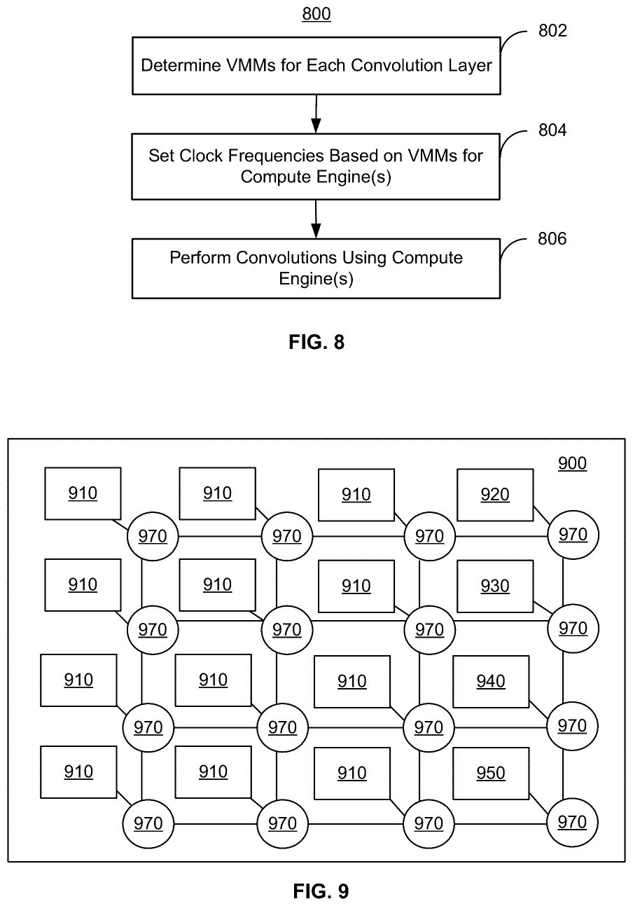

FIG. 8 is a flow chart depicting an embodiment of method 800 for more efficiently performing convolutions. Method 800 is described in the context of compute tile 100. However, method 800 is usable with other compute tiles and/or other compute engines. Although particular processes are shown in an order, the processes may be performed in another order, including in parallel. Further, processes may have substeps. In some embodiments, at least part of method 800 may correspond to step 708 of method 700.

The number of VMMs performed by compute engines for each kernel may be determined, at 802. For example, some kernels used for some convolutions in a learning network may require fewer VMMs. For example, the matrices of weights forming the kernels and stored in the compute engines may have a different number of columns and/or rows. Thus, the total time taken to perform the VMMs may differ.

The clock frequencies of the compute engines being used are set based on the kernels, at 804. More specifically, the frequency for a compute engine performing more VMMs may be set higher than the frequency for a compute engine the performs fewer VMMs. For example, 804 may include setting two bits for each compute engine. The four possible combinations of bits correspond to four possible frequencies. For example, 00 may be a first frequency f1, 01 may correspond to a second frequency (f2, which may be 6f1), 10 may correspond to a third frequency (f3, which may be 7f1), and 11 may correspond to a fourth frequency (f4, which may be 4f1) of the compute engine. As a result, the total time for each compute engine to perform its VMMs may be closer. Suppose a first compute engine performs 900 VMMs, while a second compute engine performs 1800 VMMs for its kernel. The first compute engine may have clock frequency f1 (bits set to 00), while the second compute engine has its clock frequency set to f2=2f1 (bits set to 01). In other embodiments, other encoding schemes and other frequencies may be used. At 806, the convolution is performed using the compute engines and the clock frequencies set at 804.

For example, suppose compute engine 120-1 performs m VMMs, while compute engine 120-2 performs 3m VMMs. These numbers of VMMs are determined at 802. At 804, the clock frequencies for compute engines 120-1 and 12-2 are set. For example, compute engine 120-1 may have frequency f1 (bits 00), while compute engine 120-2 has frequency f3=3f1 (bits 10). At 806, compute engines 120-1 and 120-2 are used to perform VMMs for convolutions. For example, compute engine 120-1 may perform VMMs for a first kernel, while compute engine 120-2 performs VMMs for a second kernel. Compute engine 120-1 performs its VMMs for a first portion of the data. The resultant is provided to compute engine 120-2 (optionally with other processing such as the application of activation functions performed first). While compute engine 120-2 operates on this first portion of data, compute engine 120-1 may operate on a second portion of data. As a result, compute engine 120-2 may complete its VMMs for the first portion of data at approximately the same time as compute engine 120-1 completes VMMs for the second portion of data. Thus, data may be more efficiently pipelined.

Using method 800, the time taken for each compute engine to complete its VMMs may be harmonized. Consequently, pipelining of a learning network using method 800 may be improved and processing of data more efficient. Consequently, performance of the learning network may be enhanced.

FIG. 9 depicts an embodiment of architecture 900 including multiple tiles employing compute engines and usable in an AI accelerator that may efficiently perform convolutions. In some embodiments, architecture 900 may be considered a system on a chip (SoC) or a network on a chip (NoC). SoC 900 includes compute tiles 910, a DDR controller 920, PCIe or other analogous module 930, peripheral I/O module 940, management control processor (MCP) 950, and routers/mesh interconnects 970. Other and/or different components may be included. DDR controller 920 allows for DRAM (not shown) to be coupled with SoC 900. PCIe module 930 allows for connectivity to a host (not shown). Peripheral I/O module 940 may be merged with MCP 950 in some embodiments. MCP 950 may perform housekeeping and other management functions for SoC 900. Via routers/mesh interconnects 970 and modules such as mesh stops, such as mesh stops 280 and/or 380, tiles 910 may be interconnected.

In SoC 900, each tile 910 is an independent compute unit which has its own local memory analogous to SRAM 130. Tiles 910 are interconnected by mesh interconnects. In some embodiments, this allows any tile 910 to access the memory of any other tile 910. For example, the GP processor, compute engine(s), and/or memory of a first compute tile 910 may exchange data with (e.g. send data to and/or receive data from) a component (e.g. GP processor, compute engine(s), and/or memory) of another compute tile 910. Tiles 910 each have memory that is fully globally addressable. In some embodiments, a tile 910 may interact with any other tile 910 of SoC 900. Thus, tiles 920 may be considered to be tightly-coupled, independent compute and memory blocks with globally addressable memory that enable a compiler (not shown in FIG. 9) to create custom super tiles. Super tiles can be formed by some combination of two or more tiles 910. Super tiles may be used to create custom pipelines for scheduling computational graphs for execution using SoC 900 and/or for other purposes. In some embodiments, for example, an arbitrary computational graph can be mapped to SoC 900 via super tiles. The mesh interconnection of tiles 900 in SoC may reflects the custom traffic patterns observed on SoC 900. The custom traffic patterns might require support for multicast, broadcast for various operators (e.g. BatchNorm). In other embodiments, other and/or additional features may be supported based upon the traffic patterns.

Using SoC 900 efficiency and performance of a learning network, including performing convolutions, may be improved. In addition to the benefits of the individual tiles 900, such as more efficient control and movement of data within a tile, SoC 900 may extend the benefits to larger systems. Through super tiles, SoC 900 may be tailored to the specific traffic patterns and applications with which SoC 900 is desired to be used. Consequently, efficiency and performance may be enhanced.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for performing a convolution, comprising:
providing an activation to a general purpose (GP) processor, the GP processor being coupled with a plurality of compute engines, each of the plurality of compute engines including a compute-in-memory (CIM) hardware module, the CIM hardware module storing a plurality of weights corresponding to a kernel and being configured to perform a vector-matrix multiplication (VMM) for the kernel;
performing, by the GP processor or at least one of the plurality of compute engines, a quantization of the activation to provide a quantized activation;
performing, by the at least one of the plurality of compute engines, the VMM for the quantized activation and the kernel to provide a product; and
performing, by the GP processor or the at least one of the plurality of compute engines, a dequantization of the product.

2. The method of claim 1, wherein the GP processor performs the quantization of the activation, the method further comprising:
providing, by the GP processor to the at least one compute engine, the quantized activation.

3. The method of claim 2, wherein the performing the quantization further includes:
providing, to a vector register file of the GP processor, the activation;
performing, by a vector processing unit of the GP processor, the quantization; and
writing, to the vector register file of the GP processor, the quantized activation.

4. The method of claim 2, further comprising:
storing the activation in an on-tile memory, the activation being an image-to-column transformed activation.

5. The method of claim 4, wherein the on-tile memory includes at least one of a static random access memory (SRAM) and a dynamic random access memory (DRAM).

6. The method of claim 2, further comprising:
setting a clock frequency in the at least one compute engine based on a number of VMMs performed by the at least one compute engine.

7. The method of claim 6, wherein the setting the clock frequency further includes:
setting a plurality of bits, a combination of values of the plurality of bits corresponding to the clock frequency of a plurality of clock frequencies.

8. The method of claim 1, wherein the at least one compute engine performs the quantization of the activation, the method further comprising:
providing, by the GP processor to the at least one compute engine, an unquantized activation.

9. A compute tile, comprising:
a plurality of compute engines, each of the plurality of compute engines including a compute-in-memory (CIM) hardware module, the CIM hardware module storing a plurality of weights corresponding to a matrix and configured to perform a vector-matrix multiplication (VMM) for the matrix, the matrix corresponding to a kernel; and
a general-purpose (GP) processor coupled to the plurality of compute engines and configured to provide control instructions and data to the plurality of compute engines, the GP processor further being further configured to receive an activation;
wherein the GP processor or at least one compute engine of the plurality of compute engines is configured to perform a quantization of the activation to provide a quantized activation, the at least one compute engine being configured to perform the VMM for the kernel and the quantized activation to provide a product, and the GP processor or the at least one compute engine being further configured to perform a dequantization of the product.

10. The compute tile of claim 9, wherein the GP processor performs the quantization of the activation, the GP processor further being configured to provide to the at least one compute engine, the quantized activation.

11. The compute tile of claim 10, wherein to perform the quantization, the GP processor is further configured to:
receive, at a vector register file of the GP processor, the activation;
perform, by a vector processing unit of the GP processor, the quantization; and
write, to the vector register file of the GP processor, the quantized activation.

12. The compute tile of claim 10, further comprising:
on-tile memory configured to store the activation, the activation being an image-to-column transformed activation.

13. The compute tile of claim 12, wherein the on-tile memory includes at least one of a static random access memory (SRAM) and a dynamic random access memory (DRAM).

14. The compute tile of claim 10, wherein the GP processor is further configured to set a clock frequency in the at least one compute engine based on a number of VMMs performed by the at least one compute engine.

15. The compute tile of claim 14, wherein to set the clock frequency, the GP processor is further configured to set a plurality of bits, a combination of values of the plurality of bits corresponding to the clock frequency of a plurality of clock frequencies.

16. A system, comprising:
a plurality of compute tiles, each of the plurality of compute tiles including a general-purpose (GP) processor and a plurality of compute engines coupled with the GP processor, each of the plurality of compute engines including a compute-in-memory (CIM) hardware module, the CIM hardware module storing a plurality of weights corresponding to a matrix and configured to perform a vector-matrix multiplication (VMM) for the matrix, the matrix corresponding to a kernel, the GP processor being configured to provide control instructions and data to the plurality of compute engines, the GP processor being further configured to receive an activation, to perform a quantization of the activation to generate a quantized activation, and to provide the quantized activation to at least one compute engine of the plurality of compute engines, the at least one compute engine being configured to perform the VMM for the kernel and the quantized activation to provide a product, the GP processor being further configured to perform a dequantization of the product

17. The system of claim 16, wherein to perform the quantization, the GP processor is further configured to:
receive, at a vector register file of the GP processor, the activation;
perform, by a vector processing unit of the GP processor, the quantization; and
write, to the vector register file of the GP processor, the quantized activation.

18. The system of claim 16, wherein each of the plurality of compute tiles further includes on-tile memory configured to store the activation, the activation being an image-to-column transformed activation.

19. The system of claim 16, wherein the GP processor is further configured to set a clock frequency in the at least one compute engine based on a number of VMMs performed by the at least one compute engine.

20. The system of claim 16, wherein at least one of the GP processor and a compute engine of the plurality of compute engines of a first compute tile of the plurality of compute tiles exchanges data with a component of a second compute tile of the plurality of compute tiles, the second compute tile being different from the first compute tile.
